(19) United States
(12) Patent Application Publication
(10) Pub. No.: US 2020/0406780 A1
(43) Pub. Date: Dec. 31, 2020

(54) MODULAR ELECTRIC BATTERY-POWERED SYSTEMS AND METHODS

(71) Applicant: Ample, Inc., San Francisco, CA (US)

(72) Inventor: Khaled Walid Hassounah, San Francisco, CA (US)

(21) Appl. No.: 16/914,687

(22) Filed: Jun. 29, 2020

Related U.S. Application Data
(60) Provisional application No. 62/868,352, filed on Jun. 28, 2019.

(51) Int. Cl. B60L 53/80; H01M 2/10; B60L 53/35; B60L 53/30

(52) U.S. Cl. CPC B60L 53/80; B60L 53/305; B60L 53/35; H01M 2/1083

(57) ABSTRACT

A system and method for powering electric vehicles and other equipment is provided. In some aspects, an electric vehicle is powered by a modular set of battery modules which are removeable when depleted and individually replaceable with fresh charged modules on demand. Determination of the overall total battery capacity needed allows for operation of the vehicle or machine using all or a subset of all possible battery modules installed therein. Robotic replacement of the modules and servicing at a battery module service station is also described.

### CROSS-REFERENCE TO RELATED APPLICATIONS

This application claims priority to U.S. Provisional Application No. 62/868,352, filed Jun. 28, 2019, titled “Modular Electric Battery-Powered Systems and Methods,” which is hereby incorporated by reference.

### TECHNICAL FIELD

The present application relates to powering and operating electric vehicles such as electric cars driven by rechargeable battery powered motors.

### BACKGROUND

Electric cars, golf carts, fork lifts and similar machines are sometimes driven by electric motors that are battery-powered. These traditional electric vehicle power units comprise a monolithic battery unit that is rechargeable. When the vehicle's stored electric energy is low or depleted, the operator takes the vehicle to a charging station (private or public) and connects the vehicle charging system to a replenishment power supply such as high- or low-voltage AC utility power. Once the vehicle's battery is recharged, the vehicle can be put back into service.

FIG. 1 represents a conventional electric vehicle 100 according to the prior art. The vehicle 100 is serviced by an external electric supply or charging station 110 and carries a sizeable electrical energy storage unit or battery 120, encased in a sealed housing located at or near a lower portion of the vehicle's chassis to lower the car's center of gravity. The battery 120 has an electrical interface, plug, port, jack or similar member 102 through which the vehicle/battery can accept electric energy from charging station 110. Charging station 110 provides a voltage and/or current through a conducting charging cable 112, plugged into charging port 102 to replenish the spent energy in battery 120. Power from battery 120 is provided over electrical bus lines 106 to electric loads in the vehicle such as to electric drive motor(s) 130, which are used to power the drivetrain 140. The battery 120 is a permanent and significant component in the overall vehicle architecture and is generally not built to be accessible or serviceable by the user of the vehicle and is furthermore usually tightly sealed and enclosed in a permanent housing that is not designed to be removed or serviced during normal operation.

Since a vehicle like a car, truck or bus requires significant energy to operate, large electric power storage units (e.g., batteries) are required to store and provide the needed Amp-hours for a practical use of such vehicles between charges. Manufacturers, aware of consumer concerns regarding the traditionally limited operating range of electric cars, have equipped their electric vehicles with as much battery capacity as practicable within design and cost constraints. Current electric vehicles carry substantial battery units that can deliver a minimum performance (range) to be commercially viable. Such batteries are large, expensive and very heavy, especially as the core materials used in electric batteries include heavy metals, conductors and other dense components.

The industry strategy to load electric cars with large and heavy battery units has several drawbacks countering their range advantages. For example, typical electric car battery units require relatively long times to charge properly, despite some attempts to “quick charge” batteries, which requires very costly charging stations and can degrade the long-term performance of the batteries. Also, large and heavy batteries in electric cars mean that a substantial amount of energy is needed to transport the battery of a car on account of the dead weight of the battery unit itself. The energy needed to transport the battery around within an electric car is generally a waste of energy, which somewhat defeats the environmental virtues of running an electric car as the electric energy to charge car batteries is typically transported over the electric power grid from distant locations and is subject to line losses and other inefficiencies. Additionally, the battery unit of a typical electric car is one of the largest and more expensive components of the car. If the battery is damaged or needs service, the entire car is put out of commission during the repair process, which can require removal of the monolithic battery unit from the car, usually involving substantial cost and effort to remove, repair and/or replace the same.

This disclosure describes and claims systems and methods for electric vehicles and their batteries.

### SUMMARY

Example embodiments described herein have innovative features, no single one of which is indispensable or solely responsible for their desirable attributes. The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Without limiting the scope of the claims, some of the advantageous features will now be summarized. Other objects, advantages and novel features of the disclosure will be set forth in the following detailed description of the disclosure when considered in conjunction with the drawings, which are intended to illustrate, not limit, the invention.

An embodiment is directed to a system for powering an electric vehicle, comprising a plurality of electrically-coupled battery modules, each battery module comprising at least one rechargeable battery cell capable of providing electrical power to the system; at least one battery housing unit configured and arranged to support said battery modules, said battery housing unit further comprising electrical connection points that electrically connect, respectively, to said battery modules; and a controller configured and arranged to electrically connect or disconnect said battery modules to or from said system, and said controller selectively electrically connects a set of said battery modules to the system. In one or more embodiments, the controller configured and arranged to configurably connect or isolate respective ones of the plurality of battery modules and other parts of said system. In some embodiments, the controller configured and arranged to receive an input signal indicative of a vehicle operating condition and to electrically connect or disconnect one or more of said battery modules to the system responsive to said vehicle operating condition. In yet other embodiments, the battery housing unit configured and arranged to accommodate a plurality of loading configurations so that the battery housing unit may be loaded on demand with a variable number of said battery modules. Yet other embodiments comprise an electrical power bus coupling said battery modules to an electric vehicle drive system and/or a data signaling bus coupling said controller to a vehicle controller.

A further embodiment is directed to a method for powering an electric vehicle using a modular variable-capacity electric power system, the method comprising determining a required electric capacity for a planned use of said electric vehicle; placing said electric vehicle in data communication with a battery installation apparatus configured and arranged to install battery modules into said electric vehicle; detaching, using the battery installation apparatus, a battery housing from the electric vehicle, the housing configured and arranged to hold a plurality of electrically-coupled battery modules; installing, using the battery installation apparatus, one or more battery modules into said variable-capacity electric power system so as to additively provide at least said required electric capacity; and securing, using the battery installation apparatus, said battery housing to the electric vehicle after the one or more battery modules are installed into said battery housing.

### BRIEF DESCRIPTION OF THE DRAWINGS

For a fuller understanding of the nature and advantages of the present concepts, reference is made to the detailed description of preferred embodiments and the accompanying drawings.

FIG. 1 illustrates a conventional electric vehicle and charging station.

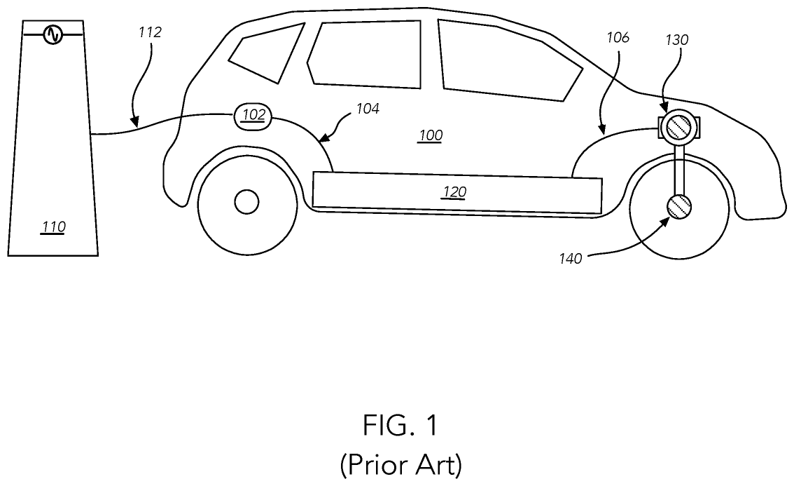

FIG. 2 illustrates an electric vehicle with swappable battery modules according to an embodiment.

FIG. 3 illustrates an electric vehicle with swappable battery modules and battery servicing infrastructure according to an embodiment.

FIG. 4 illustrates an electric vehicle with both swappable and rechargeable battery operation according to an embodiment.

FIG. 5 illustrates loading an electric vehicle with a subset of the total possible battery modules based on a determined needed battery capacity according to an embodiment.

FIG. 6 is a flow chart of a method for powering an EV using a modular electric power system according to an embodiment.

FIG. 7 is a flow chart of a method for powering an EV using a modular electric power system according to an alternative embodiment.

FIG. 8 is a flow chart of a method for installing battery modules in an EV having a modular electric power system.

### DETAILED DESCRIPTION

As mentioned earlier, conventional electric vehicle power units comprise batteries that are large, heavy, expensive and difficult or impossible to service. Energy is wasted in transporting such massive battery units, even when the vehicle does not require a full battery charge to achieve its user's needs. Furthermore, conventional electric vehicles are inflexibly configured with such battery systems, which are typically custom made in their size and configuration to fit a given vehicle chassis.

The present disclosure presents novel systems and methods for battery systems that can be used in electric vehicles of many sorts, e.g., cars, trucks, buses, vans, boats, airplanes, drones, military vehicles, and others (generally referred to as vehicles herein). An electric car may be given herein as an example of such vehicles, but the present disclosure is not intended to be limited to these examples, and those skilled in the art will understand that a range of other machines and vehicles can be similarly equipped and operated.

In an aspect, the present invention allows for a modular battery system comprising a plurality of individual battery modules, which themselves can comprise a plurality of battery cells or groups of cells. The present battery modules can be configurably inserted into an electric vehicle as needed and on demand. For example, a vehicle going on a long journey and requiring a larger battery capacity may be outfitted with a full complement of battery modules, while a vehicle going on a shorter journey may be outfitted with only a subset of the total possible battery module capacity of the vehicle. By placing only the needed number of battery modules into the vehicle, the vehicle can gain performance and economy advantages because it is not loaded with additional heavy battery materials beyond what is needed to carry out its upcoming duties.

In another aspect, the present invention allows for swapping of depleted battery modules into a vehicle by removing one or more depleted battery modules from the vehicle and replacing these removed battery modules with fresh or charged battery modules.

In yet another aspect, the present invention allows for generic or shape/size independent battery modules that are fitted as needed into vehicles of various and differing configurations. So rather than design and build a large monolithic car battery which only fits a given car model, the present battery modules can be placed into numerous shape and size battery compartments in a modular fashion, making them model agnostic and useful across a wider variety of vehicles.

In still another aspect, the present invention allows for economical and practical servicing of battery systems in electric vehicles. Prior electric vehicles with malfunctioning batteries required extensive operations to remove the large monolithic battery units therefrom, and time-consuming and costly replacement thereof, taking the affected vehicle out of service until a repaired or new battery is installed. By contrast, the present invention allows for inexpensive and rapid swapping out of any depleted, damaged or under-performing battery module, which can be simply replaced with a fresh or new battery module in a matter of minutes.

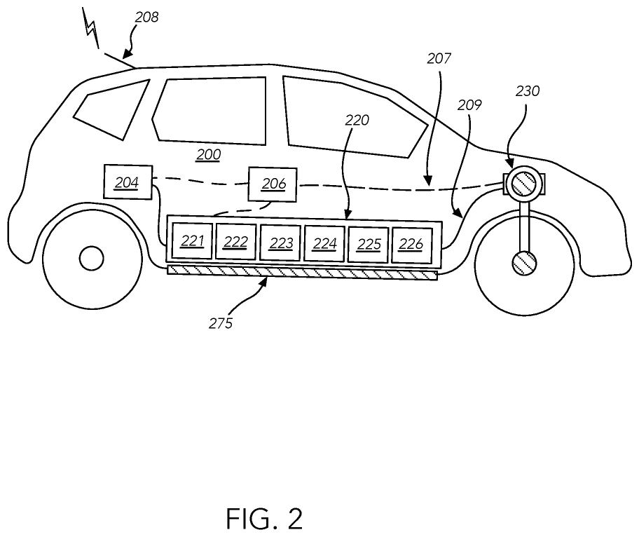

FIG. 2 illustrates some parts of an exemplary electric vehicle 200 comprising a swappable modular battery system 220. A plurality of battery modules 221-226 form the electrical energy storage unit or battery 220 and are generally housed in one or more battery housing compartments. The vehicle 200 also comprises a battery controller circuit 204 and a central processor 206, which can be implemented as separate units or as one unit, depending on the application and other design needs. The plurality of modular battery modules 221-226 are accessed for replacement, inspection or service through a battery access port 275 as is discussed in more detail elsewhere.

Power (voltage and/or current) is regulated and delivered over power buses 209 to one or more electrical loads of the vehicle such as the electric drive motor 230, the vehicle's electrical accessories, and other loads. Control signal lines or buses 207 (shown as dashed lines) deliver data and other measurement signals, instructions and command signals among various components of the vehicle's electrical and electronic system. Such control signals can for example start up or secure/shut down a component in the system, place one or more battery modules in or out of service, deliver performance and capacity information to a central computer 206, or deliver wireless diagnostic data regarding the vehicle's operations to an external server over a wireless communication network through communication link 208.

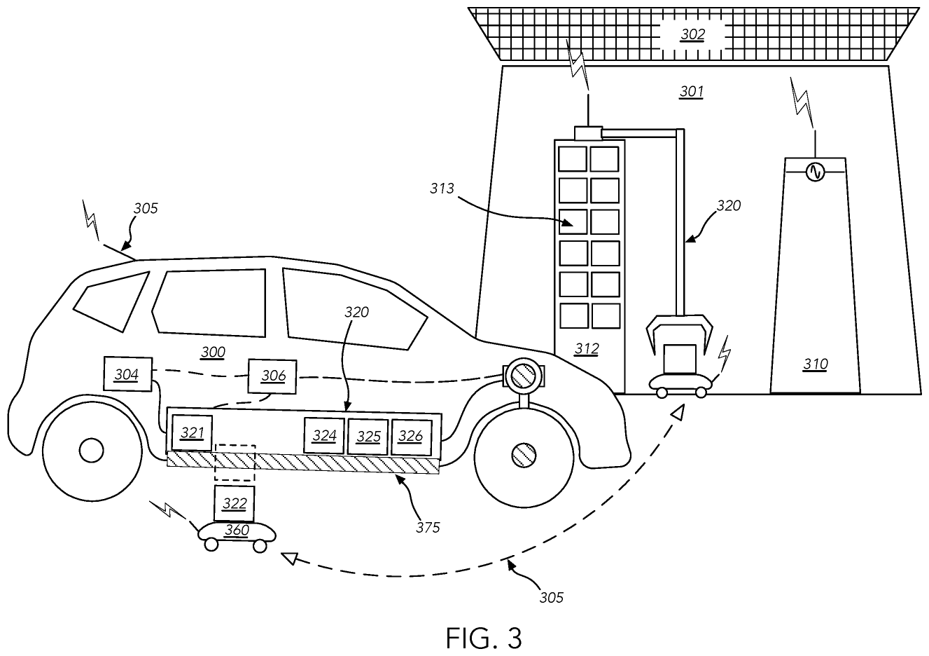

FIG. 3 illustrates an electric vehicle 300 with the present multi-module battery system 320, comprising a plurality of battery modules 321-326 housed in one or more battery housing chambers. A battery access port 375 permits access to the plurality of battery modules 321-326. As shown schematically, the battery 320 may be loaded with a full complement of battery modules, or with a subset of said battery modules (less than a full load) depending on the system or user's needs.

The mechanical aspects of swapping or replacing individual battery modules are discussed by the present Applicant elsewhere, wherein an entire tray or compartment of battery modules, or one or more such battery modules are accessed for replacement or inspection. For the present purpose, we note that such one or more battery modules (for example battery module 322) can be removed or replaced by a human or machine agent.

The figure illustrates a mobile autonomous robot 360 that is configured and programmed or equipped to access and remove or replace one or more battery modules 321-326. The robot 360 can take a depleted battery module 322 (or more modules) and travel along some path 305 between the vehicle 300 location and a battery service station 301. Once a depleted battery module 322 is transported to the battery service station 301, a human or a mechanical agent can place the depleted battery module 322 into a charging or servicing rack 312, e.g., by picking up the depleted battery module 322 with an articulated mechanical arm 320.

The battery service station 301 can include battery storage rack 312 configured to support several battery modules 313, including depleted battery modules awaiting charging, charged battery modules awaiting installation into a vehicle, or damaged battery modules awaiting service and repair. The battery service station 301 can also house a battery charging station 310, which provides electrical power to recharge one or more depleted battery modules. The battery charging station 310 may itself receive electrical power from a generator, a utility service line, and/or a solar power installation 302. The battery charging station 310 may be disposed separately from battery service station 301, or may be integrated therein as shown. An example of the battery service station 301 and mobile autonomous robot 360 is disclosed in U.S. Pat. No. 9,868,421, titled “Robot Assisted Modular Battery Interchanging System,” which is hereby incorporated by reference.

Fresh or recharged battery module(s) may be brought by a human or mechanical agent from the battery service station 301 to vehicle 300 and installed into the battery system 320. The vehicle 300 is now free to continue its journey with a desired battery capacity installed.

Therefore, the present system and method provides for a dynamic and selectable or programmable and variable battery capacity in electric vehicles. The capacity available and installed in a vehicle may depend on any number of factors such as the length of an intended journey (the more miles or hours to be traveled the more capacity is loaded into the vehicle). Also, the travel route, terrain, traffic, and environmental conditions may be factored into determining the battery capacity to load into the battery system and vehicle. In addition, the capacity of the system may be wholly or partially based on historical data, learned performance, look-up-table data, or based on input from an on-board or external machine learning system coupled to a database or source of operational data indicative or a minimum battery capacity required for a certain use. A mapping or route planning software may also provide input (e.g., route length and route type) used in calculating a necessary battery capacity in the present variable capacity system and method.

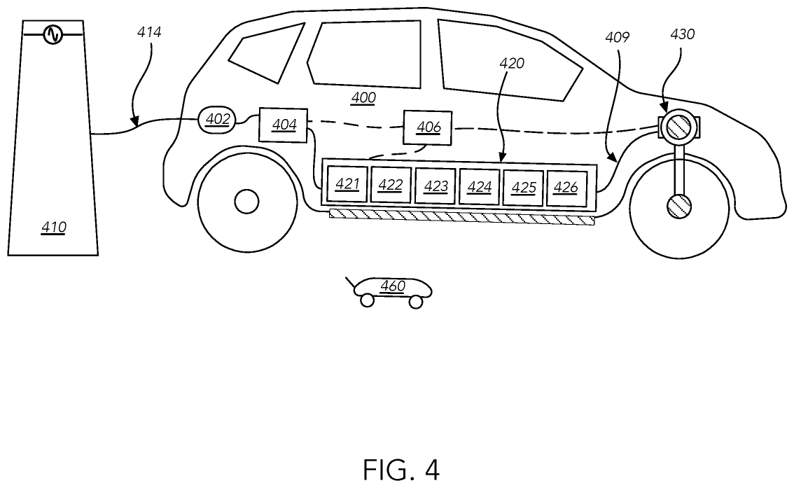

FIG. 4 illustrates another embodiment of an electric vehicle 400 with a multi-module battery system 420. In this embodiment, the battery system 420 is both rechargeable in the vehicle, which is achieved by plugging a charging cable 414 from a charging port 402 on the vehicle to a charging station, AC power source, DC power source, or other power supply source 410 that provides electrical energy to recharge the battery modules 421-426 et seq. In addition, some or all battery modules 421-426 may be swappable so as to replace depleted battery modules with fresh or charged modules as needed. An automated mechanism, a human operator or service robot 460 may be employed as described herein to accomplish the swapping procedure. On-board battery management circuitry 404 can regulate or coordinate or control or monitor the process of charging and/or swapping the battery modules. Also, a connected processor 406 can provide, regulate, control and/or monitor delivery of power to loads such as electric drive motors 430 over power line 409.

In one non-limiting aspect, a given battery module (e.g., module 423) may be charged from charging station 410 or swapped with a fresh battery module if it is depleted. In another aspect, a subset of battery modules (e.g., modules 421, 422, 423) are rechargeable from charging station 410 but not swappable, while other modules (e.g., 424, 425, 426) are swappable but not rechargeable from charging station 410. That is, the present disclosure is not limited to recharging or swapping of battery modules 421-426. Rather, in some optional embodiments, the invention may mix in-vehicle charging and replacement (swapping) of battery modules as suits a given application without loss of generality.

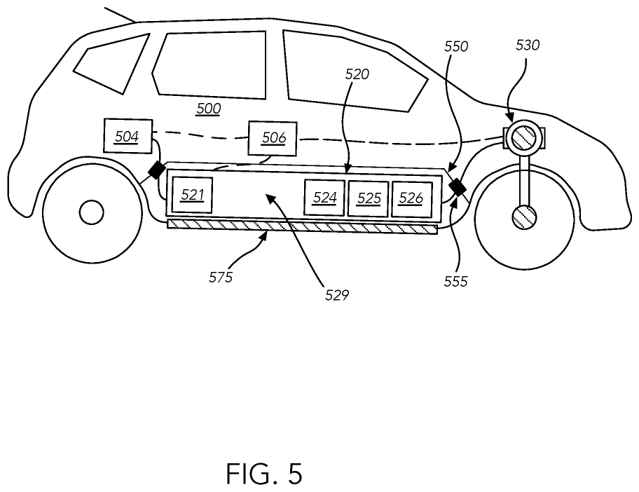

FIG. 5 illustrates an exemplary electric vehicle 500 having swappable electric battery modules 521, 524, 525, 526 etc. as described earlier. The modules are housed in one or more housings of battery system 520, and are accessible by a human or machine service agent through one or more access ports or covers 575 as described. We note in this example, that a fraction 529 of battery system 520 is left empty or void (unloaded), perhaps to save on overall vehicle weight if the anticipated range needed does not require loading the vehicle with a full complement of battery modules. In other words, a user or expert system or computer application may determine a minimum or a reasonable battery capacity and load the battery 520 with only the minimum or the reasonable number of modules so as to carry out the vehicle's needed mission. In passenger, commercial, military, freight or fleet applications, this approach can result in significant overall and cumulative cost savings, energy efficiency and environmental benefits (i.e., not carrying around excess heavy battery modules when not required). The fraction of the total possible battery load or capacity installed in a vehicle can be determined mathematically by a machine-assisted computer program and processors that execute said program instructions. The installed battery capacity can range almost arbitrarily from a small requirement, e.g., 10 percent or less, to a full capacity, i.e., about 100 percent. Fresh battery modules can be picked up or installed at any suitable service station equipped with the present modular battery support infrastructure such as that described above.

The present modular battery system can be installed in vehicle-agnostic housing units as shown that house a plurality of such rechargeable modular battery units. The modules themselves can hold a design Amp-hour capacity determined by their individual size, materials and construction. An interface plate 550 can provide mechanical and/or electrical communication between the battery system 520 and the remaining electrical loads and control circuits of the vehicle 500. The interface plate 550 (or a wall of the housing of battery system 520) can contain electrical connections or connection points 555 to each battery module 521-526, or to groups of modules.

A battery charging management or controller circuit 504 may be dedicated to operations regarding managing and monitoring the condition of the battery system 520 or its sub-components and battery modules 521-526. Controller circuit 504 may actuate mechanical, electrical and/or electro-mechanical actuators so as to selectively connect or disconnect any given battery module (or subset of modules) into the car's battery system during operation. That is, one or more individual modules, while installed, may be selectively cut out of use by electrical or mechanical isolation of the cut out or unused modules. If a specific module is found to be damaged, over-heated, or otherwise unnecessary or harmful to the operation of the overall system, it can thus be disconnected while the vehicle continues normal operations and until the vehicle can return to a battery module service station where the affected module will be removed and replaced.

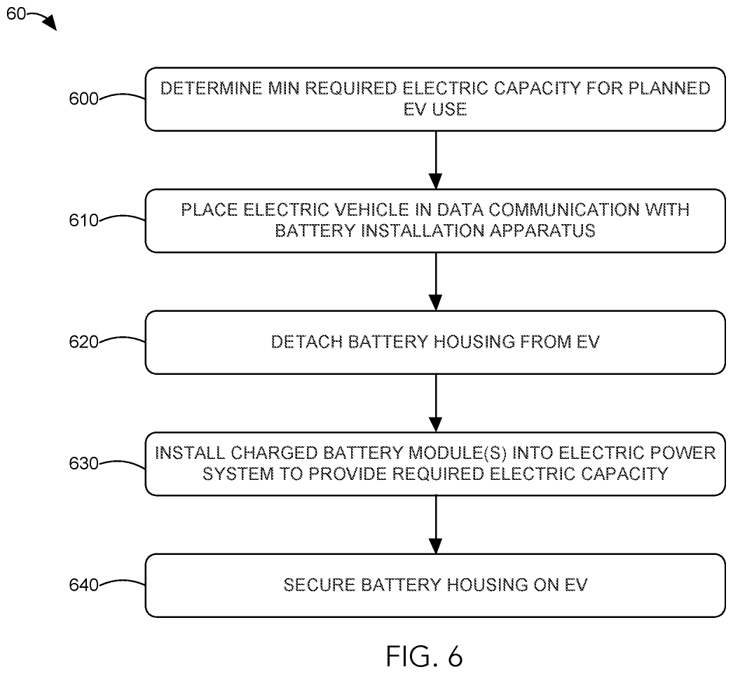

FIG. 6 is a flow chart 60 of a method for powering an EV using a modular (e.g., variable-capacity) electric power system according to an embodiment. In step 600, the EV determines or estimates the minimum required electric capacity for a given, planned, or intended (in general, “planned use”) of the EV. For example, the EV can have one or more user-selectable operating modes and the EV's central computer (e.g., central processor 206) can be configured to determine the required electrical capacity for the selected operating mode. The EV operating modes can include (a) commuting, (b) local errands, (c) maximum range, (d) custom, and/or (e) another operating mode. The EV's central computer can determine the required electrical capacity for each EV operating mode using historical data, estimates, and/or other factors.

For example, in the commuting operating mode, the EV's central computer can use as inputs the operator's home address and the operator's work address, for example, to determine the operator's commuting distance. The EV's central computer can use as a default that the required electrical capacity is that necessary for a round-trip commute. However, if the operator has access to an EV charging station at work, the operator can set the required electrical capacity as that necessary for a one-way commute. The operator can also provide the EV's central computer with the time that he/she intends to leave home and depart work, which can be used by the EV's central computer to estimate traffic, which can increase the required electrical capacity for the commute. In another embodiment, the operator can select a one-way or two-way travel range to use in the commuting operating mode. For example, a one-way travel range of 15 miles or a two-way travel range of 30 miles. In yet another embodiment, the EV can have a default commuting operating mode with a two-way travel range of 50 miles, which may be suitable for most operators.

In the local errands operating mode, the EV's central computer can use as inputs the desired travel range (e.g., within a 10-mile radius of home or other location), the number of stops, and/or other factors. The EV's central computer can use these inputs to estimate the required electrical capacity. In some embodiments, the operator can select whether he/she will have access to an EV charging station at any of the stops. In another embodiment, the operator can select a one-way or two-way travel range to use in the local errands operating mode. In yet another embodiment, the EV can have a default local errands operating mode with a two-way travel range of 20 miles, which may be suitable for most operators.

In the maximum-range operating mode, the EV's central computer can indicate that the required electrical capacity is equal to the maximum electrical capacity of the EV. In this embodiment, all battery modules (e.g., battery modules 521-526) are used to maximize EV range.

In the custom operating mode, the EV's central computer can use as inputs a custom travel range. For example, the operator may plan on visiting a friend that lives 75 miles away. Therefore, the required electrical capacity can correspond to at least 150 miles if a round-trip is needed or 75 miles if only a one-way trip is needed (e.g., if the friend has an EV charger). The operator can further customize the travel range based on what he/she intends to do after visiting the friend and/or along the way, which may require additional electrical capacity.

In an alternative embodiment, the battery recharging system can include a central computer that can determine the required (e.g., minimum) electric capacity for the planned use of the EV in the same manner as discussed above. In yet another embodiment, the EV and/or the battery recharging system can be in network communication with a computer that determine the required (e.g., minimum) electric capacity for the planned use. The computer can comprise a server, a smartphone, and/or another computer. In another alternative embodiment, the EV and/or the battery recharging system can be in network communication with the operator's computer to receive the planned use. The operator's computer can comprise a personal computer (e.g., laptop, desktop, tablet, etc.), smartphone, smart watch, or another computer. The operator's computer can include a dedicated application and/or a web application through which the operator can indicate his/her planned use of the EV.

The EV's central computer can determine the required electrical capacity for each EV operating mode using historical data for the EV and/or using historical data for other EVs. The historical data for the EV can be collected by the EV's central computer, by the battery recharging system (e.g., via a network communication with the EV), and/or by a network-accessible server (e.g., via a network communication with the EV). The historical data of other EVs can be stored in computer memory in the EV that is accessible to the EV's central computer, in the battery recharging system, and/or in a network-accessible server. In some embodiments, machine learning (e.g., an artificial neural network or other machine learning) can be used to analyze the EV's historical data and/or the historical data of other EVs to determine the required electrical capacity.

In step 610, the EV is placed in data communication with a battery installation apparatus that is configured and arranged to install battery modules into the EV. A data communication link between the EV and battery installation apparatus can comprise a network connection, a direct connection, or other connection. The connection data communication can be achieved using wired and/or wireless connections.

The EV can communicate, over the data communication link, status information regarding of the EV's modular electric power system (e.g., modular battery system 220). The status information can include the capacity of the EV's modular electric power system, the number of battery modules installed in the EV's modular electric power system, and/or the energy status (e.g., depletion status) of each installed battery module. In addition, the EV can transmit one or more commands over the data communication link that cause the battery installation apparatus to install, remove, and/or replace battery modules in the EV's modular electrical power system.

In addition, the EV can communicate, over the data communication link, the required electrical capacity to the battery installation apparatus. Alternatively, the EV can communicate the planned use (e.g., operating range, operating mode, and/or other planned use, as discussed above) to the battery installation apparatus, which can determine or estimate the required electrical capacity (e.g., based on the type of EV and/or other factors). In another alternative embodiment, the operator's computer can communicate (e.g., over a network connection) the planned use to the EV and/or to the battery installation apparatus.

In step 620, the housing or cover for the EV's modular electric power system is removed manually or automatically (e.g., via a robot such as mobile autonomous robot 360). Removing the housing or cover exposes the battery modules which allows them to be removed and/or installed.

In step 630, the battery installation apparatus is used to install at least one battery module into the modular electric power system to increase its electric capacity to additively provide at least the electric capacity required for the planned use. In some embodiments, one or more (e.g., some or all) of the battery modules that are already installed (e.g., prior to installing any battery modules in step 630) are removed by the battery installation apparatus. For example, one or more depleted or partially-depleted battery modules can be replaced with one or more corresponding fully-charged battery modules to provide the required electric capacity for the planned use. One or more additional charged battery modules can also be installed. Thus, the net number of battery modules in the modular electric power system can be increased as a result of step 630.

After the battery module(s) is/are installed in step 630, the housing or cover for the EV's modular electric power system is re-secured to the EV in step 640.

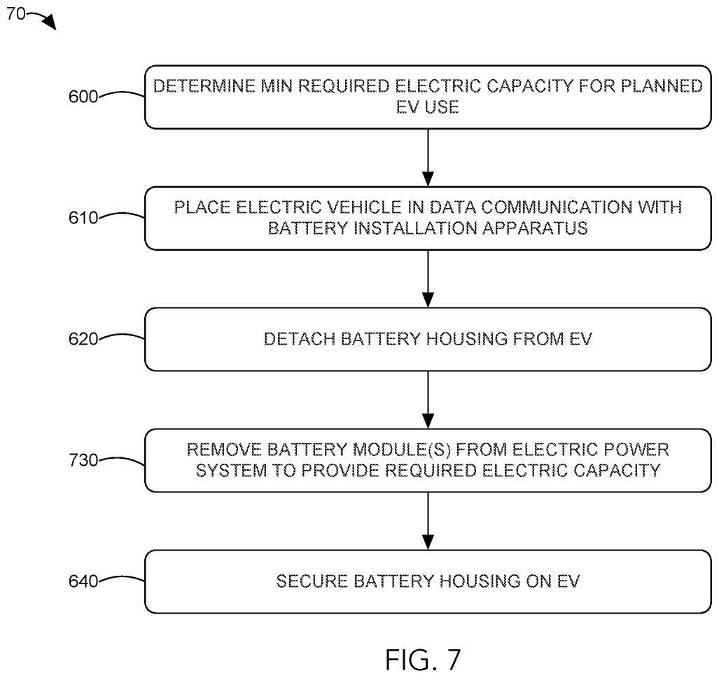

FIG. 7 is a flow chart 70 of a method for powering an EV using a modular (e.g., variable-capacity) electric power system according to an alternative embodiment. Flow chart 70 is the same as flow chart 60 except that in step 730, the battery installation apparatus is used to remove at least one battery module from the modular electric power system to decrease its electric capacity to subtractively provide at least the electric capacity required for the planned use. In some embodiments, one or more (e.g., some or all) depleted or partially-depleted battery modules in the modular electric power system can be replaced with one or more corresponding fully-charged battery modules to provide the required electric capacity for the planned use. Thus, the net number of battery modules in the modular electric power system can be decreased as a result of step 730.

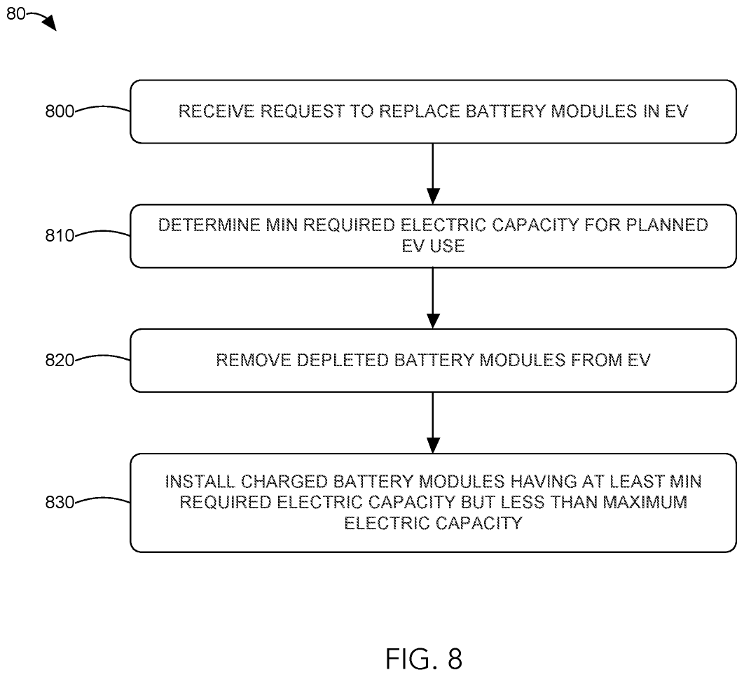

FIG. 8 is a flow chart 80 of a method for installing battery modules in an EV having a modular (e.g., variable-capacity) electric power system according to an alternative embodiment. In step 800, a battery installation system receives a request to replace the battery modules in the EV. The request can be transmitted by the EV (e.g., by a computer in the EV such as the EV's central computer), a computer (e.g., smartphone, a tablet, a personal computer, etc.) owned or operated by a user of the EV, or by another computer. In a preferred embodiment, the currently-installed battery modules in the EV are partially or fully depleted.

In step 810, a minimum required electric capacity is determined for a planned use of the EV. Step 810 can be the same as, similar to, or different than step 600 discussed above. For example, in some embodiments, the EV (e.g., the EV's central computer) determines the minimum required electric capacity and/or the planned use of the EV. In other embodiments, the battery installation system determines the minimum required electric capacity and/or the planned use of the EV. In yet other embodiments, the computer owned or operated by the user of the EV determines the minimum required electric capacity and/or the planned use of the EV. In other embodiments, a server in network communication with the EV, the battery installation system, and/or the EV user's computer can determine the minimum required electric capacity and/or the planned use of the EV. Combinations of the any of the foregoing are also possible. When a computer or entity other than the battery installation system determines the minimum required electric capacity and/or the planned use of the EV, some or all of that information can be transmitted to the battery installation system over a network connection.

In step 820, the battery installation system (e.g., using a mobile autonomous robot) removes the depleted battery modules from the EV. The battery modules can be fully or partially depleted. The battery installation system preferably places the depleted battery modules to a battery service station to charge the battery modules (e.g., now or later).

In step 830, the battery installation system (e.g., using a mobile autonomous robot) installs charged battery modules in the EV. The charged battery modules have a net electric capacity (e.g., Amp-hours) that is greater than or equal to the minimum required electric capacity determined in step 810. However, the minimum required electric capacity is less than the maximum electric capacity of the EV. Thus, the number of battery modules installed in step 830 is less than the maximum number of battery modules that can be installed in the EV.

For example, when the planned use is commuting, the battery installation system can install about 25% to 50% of the maximum number of battery modules that can be installed in the EV. Thus, the installed charged battery modules can provide about 25% to 50% of the maximum electric capacity of the EV's electric power system. In other embodiments, the battery installation system can have battery modules having different electric capacities, in which case the installed charged battery modules can provide more or less than about 25% to 50% of the maximum electric capacity of the EV's electric power system.

In some embodiments, the number of battery modules installed in step 830 is greater than the number of battery modules removed in step 820. In other embodiments, the number of battery modules installed in step 830 is lower than the number of battery modules removed in step 820. In yet other embodiments, the number of battery modules installed in step 830 is equal to the number of battery modules removed in step 820.

The present systems and methods can be applied to a broader context than just electric vehicles (cars, buses, trucks, autonomously-driven machines, etc.) This invention can be broadly applied to any electrically-powered machine that houses and relies on power from a rechargeable battery unit or units. Ships, airplanes, drones, and other industrial machinery can also benefit herefrom.

Additionally, the present disclosure comprehends an environment and infrastructure that is distributed so that geographically located battery module service stations are located across a campus, a city, or on a national or global scale. The machines and vehicles of the invention will be configured and adapted to move among such distributed service stations to replace and receive modular batteries as described.

This disclosure therefore encourages efficient interchangeable modules that can be used among many models and types of loads and vehicles and machines. So, a user is no longer committed to the battery that came installed in the user's machine or car, for example. Many machines or vehicles can be equipped to accommodate the present modular battery system.

The present invention should not be considered limited to the particular embodiments described above, but rather should be understood to cover all aspects of the invention as fairly set out herein. Various modifications, equivalent processes, as well as numerous structures to which the present invention may be applicable, will be readily apparent to those skilled in the art to which the present invention is directed upon review of the present disclosure.

We claim:

1. A system for powering an electric vehicle, comprising:
a plurality of electrically-coupled battery modules, each battery module comprising at least one rechargeable battery cell capable of providing electrical power to the system;
at least one battery housing unit configured and arranged to support said battery modules, said battery housing unit further comprising electrical connection points that electrically connect, respectively, to said battery modules; and
a controller configured and arranged to electrically connect or disconnect said battery modules to or from said system, and said controller selectively electrically connects a set of said battery modules to the system.

2. The system of claim 1, said controller configured and arranged to configurably connect or isolate respective ones of the plurality of battery modules and other parts of said system.

3. The system of claim 1, said controller configured and arranged to receive an input signal indicative of a vehicle operating condition and to electrically connect or disconnect one or more of said battery modules to the system responsive to said vehicle operating condition.

4. The system of claim 1, said battery housing unit configured and arranged to accommodate a plurality of loading configurations so that the battery housing unit may be loaded on demand with a variable number of said battery modules.

5. The system of claim 1, further comprising an electrical power bus coupling said battery modules to an electric vehicle drive system.

6. The system of claim 1, further comprising a data signaling bus coupling said controller to a vehicle controller.

7. A method for powering an electric vehicle using a modular variable-capacity electric power system, the method comprising:
determining a required electric capacity for a planned use of said electric vehicle;
placing said electric vehicle in data communication with a battery installation apparatus configured and arranged to install battery modules into said electric vehicle;
detaching, using the battery installation apparatus, a battery housing from the electric vehicle, the housing configured and arranged to hold a plurality of electrically-coupled battery modules;
installing, using the battery installation apparatus, one or more battery modules into said variable-capacity electric power system so as to additively provide at least said required electric capacity; and
securing, using the battery installation apparatus, said battery housing to the electric vehicle after the one or more battery modules are installed into said battery housing.

8. The method of claim 7, further comprising establishing a data link between said electric vehicle and said battery installation apparatus, and transmitting over said data link commands that cause said battery installation apparatus to install said one or more battery modules into said electric power system.

9. The method of claim 7, further comprising providing a planned vehicle route and using said planned vehicle route to determine the required electric capacity.

10. The method of claim 7, further comprising collecting and storing vehicle operating data and using stored past vehicle operating data to determine the required electric capacity.

11. The method of claim 7, further comprising collecting and storing operating data from electric vehicles other than said electric vehicle, and using said operating data to determine the required electric capacity.

12. The method of claim 11, further comprising analyzing said operating data using a machine learning unit to determine the required electric capacity.

13. The method of claim 7, further comprising providing a user-selected operating mode of the electric vehicle and using said user-selected operating mode to determine the required electric capacity vehicle operating condition.

14. The method of claim 13, wherein the user-selected operating mode comprises a commuting operating mode.

15. The method of claim 13, wherein the user-selected operating mode comprises a maximum-range operating mode.

16. The method of claim 7, further comprising removing, using the battery installation apparatus, one or more depleted battery modules from said electric vehicle and installing said one or more battery modules into said electric vehicle comprises installing one or more charged battery modules therein.

17. The method of claim 7, further comprising using the battery installation apparatus to increase a total number of the battery modules installed in the variable-capacity electric power system.

18. A method for powering an electric vehicle using a modular variable-capacity electric power system, the method comprising:
determining a required electric capacity for a planned use of said electric vehicle;
placing said electric vehicle in data communication with a battery installation apparatus configured and arranged to install charged battery modules into said electric vehicle and to remove depleted battery modules from said electric vehicle;
detaching, using the battery installation apparatus, a battery housing from the electric vehicle, the housing configured and arranged to hold a plurality of electrically-coupled battery modules;
removing, using the battery installation apparatus, one or more of the depleted modules from said variable-capacity electric power system so as to subtractively provide at least said required electric capacity; and
securing, using the battery installation apparatus, said battery housing to the electric vehicle after the one or more battery modules are removed from said battery housing.

19. The method of claim 18, further comprising using the battery installation apparatus to replace at least one of the removed depleted battery modules with a corresponding charged battery module to provide at least said required electric capacity, wherein there is a net decrease in a total number of the battery modules installed in the variable-capacity electric power system.

20. The method of claim 18, further comprising establishing a data link between said electric vehicle and said battery installation apparatus, and transmitting over said data link commands that cause said battery installation apparatus to remove the one or more of the depleted modules from said electric power system.

21. The method of claim 18, further comprising providing a planned vehicle route and using said planned vehicle route to determine the required electric capacity.

22. The method of claim 18, further comprising collecting and storing vehicle operating data and using stored past vehicle operating data to determine the required electric capacity.

23. The method of claim 18, further comprising collecting and storing operating data from electric vehicles other than said electric vehicle, and using said operating data to determine the required electric capacity.

24. The method of claim 23, further comprising analyzing said operating data using a machine learning unit to determine the required electric capacity.

25. The method of claim 18, further comprising providing a user-selected operating mode of the electric vehicle and using said user-selected operating mode to determine the required electric capacity vehicle operating condition.

26. The method of claim 25, wherein the user-selected operating mode comprises a commuting operating mode.
